(19) United States
(12) Patent Application Publication
(10) Pub. No.: US 2025/0136893 A1
(43) Pub. Date: May 1, 2025

(54) CHEMICAL PRETREATMENT SYSTEM FOR WASTE FAT, OIL AND GREASE

(71) Applicant: Fuzhou University, Fuzhou (CN)

(72) Inventors: Lilong JIANG, Fuzhou (CN); Kuan HUANG, Fuzhou (CN); Yanning CAO, Fuzhou (CN); Yongde MA, Fuzhou (CN); Zhenping CAI, Fuzhou (CN)

(73) Assignee: Fuzhou University, Fuzhou (CN)

(21) Appl. No.: 18/788,686

(22) Filed: Jul. 30, 2024

(30) Foreign Application Priority Data
Oct. 31, 2023 (CN) 2023114322300

(51) Int. Cl. C11C 3/04; B01D 15/08; B01D 17/04; B01J 14/00; B01J 19/06; B01J 19/24

(52) U.S. Cl. CPC C11C 3/04; B01D 15/08; B01D 17/042; B01J 14/00; B01J 19/06; B01J 19/245

(57) ABSTRACT

Provided is a chemical pretreatment system for waste fat, oil and grease (FOG), including: a catalyst preparation device; a first esterification reactor; a first separation device; a second separation device; an evaporation device set; a cooling device; and a methanol separation device. The first separation device is connected with an outlet of the first esterification reactor and connected with an inlet end of the second separation device. The second separation device is connected with an evaporation device by a first outlet and with another evaporation device by a second outlet. Outlets of multiple evaporation devices simultaneously connect with the cooling device which connects with the methanol separation device. A reflux device is connected with an outlet of the methanol separation device and also connected with the first esterification reactor.

### CROSS REFERENCE TO RELATED APPLICATION

This patent application claims the benefit and priority of Chinese Patent Application No. 202311432230.0 filed with the China National Intellectual Property Administration on Oct. 31, 2023, the disclosure of which is incorporated by reference herein in its entirety as part of the present application.

### TECHNICAL FIELD

The present disclosure relates to the technical field of renewable energy, and in particular to a chemical pretreatment system for waste fat, oil and grease (FOG).

### BACKGROUND ART

The vigorous development of biodiesel production projects not only meets the need to develop clean energy in China, but also fits the current national goal of “peak carbon dioxide emissions and carbon neutrality”. According to industry test data, every ton of biodiesel used throughout the cycle can achieve 2.0 tons to 2.5 tons of carbon emission reductions. As certified by the Dutch Double Counting of the European Union that is the largest consumer of biomass energy in the world, compared with biodiesel produced from vegetable oils such as palm oil, soybean oil, and rapeseed oil as raw materials, biodiesel produced from waste FOG such as swill-cooked dirty oil, hogwash oil, and acidified oil as raw materials has higher carbon emission reduction properties and should be vigorously promoted and used. The waste FOG is a kind of by-product of the edible oil processing industry with wide and stable sources. Compared with animal fats and vegetable oils and microbial oils, the waste FOG is relatively cheap, and thus it has obvious cost advantages as raw materials for preparing second-generation biodiesel through hydrodeoxygenation.

However, the waste FOG has high fatty acid content and high acid value, and a hydrodeoxygenation reaction is carried out under high-temperature conditions and generates a large amount of water, which seriously affects the stability of the hydrogenation catalyst and causes the catalyst bed layer to be easily pulverized and deactivated. In addition, the waste FOG also contains a large number of impurities such as metals, phospholipids, and unsaponifiable substances. The deposition of the impurities on a surface of the hydrogenation catalyst also affects the stability of the hydrogenation catalyst. Therefore, when the waste FOG is used as raw materials to prepare second-generation biodiesel, the device needs to be frequently shut down to replace the catalyst, and thus preventing stable run for a long period and resulting in high operating cost. In the existing technology for preparing the second-generation biodiesel by using the hydrodeoxygenation method, the waste FOG is generally pretreated by using conventional physical methods such as a water method, acid washing, alkali washing, and adsorption, which can remove some impurities, but has a relatively low overall efficiency, and the conventional physical pretreatment methods cannot fundamentally solve the problem of a high acid value of the waste FOG.

### SUMMARY

In the prior art, conventional physical methods such as water method, acid washing, alkali washing, and adsorption used for pretreating the waste FOG have a low removal rate of impurities, and cannot be effectively reduced the acid value of waste FOG. In view of this, the present disclosure provides a chemical pretreatment system capable of effectively reducing the acid value of the waste FOG and removing impurities in the waste FOG. A raw oil loss rate is relatively low by using the system. In addition, operation process of the system has a low cost, a decreased overall energy consumption, and a high material recycling rate.

The present disclosure provides the following technical solutions:

The present disclosure provides a chemical pretreatment system for waste fat, oil and grease (FOG), including: a catalyst preparation device, a first esterification reactor, a first separation device; a second separation device, an evaporation device set, a cooling device, a methanol separation device, a reflux device, and a raw oil supply device;
wherein the catalyst preparation device is configured to connect with an inlet of the first esterification reactor for introducing a catalyst for reaction of raw oil into the first esterification reactor;
the raw oil supply device is configured to connect with another inlet of the first esterification reactor for providing raw oil, i.e. the waste FOG, to the first esterification reactor;
the first separation device is configured to connect with an outlet of the first esterification reactor for separating a solid from a product discharged from the first esterification reactor;
the second separation device is configured to connect with an outlet of the first separation device by an inlet of the second separation device, for further separating oil and water phases of a product discharged from the first separation device;
the evaporation device set is configured for evaporating the oil and water phases separated by the second separation device and includes a first evaporation device and a second evaporation device, the first evaporation device being connected with a first outlet of the second separation device, and the second evaporation device being connected with a second outlet of the second separation device; and
outlets of the evaporation device set are simultaneously connected with the cooling device, an outlet of the cooling device is connected with the methanol separation device configured for rectifying and separating methanol and water, an outlet of the methanol separation device is connected with the reflux device, and the reflux device is connected with the first esterification reactor and configured for introducing the methanol rectified and separated by the methanol separation device into the first esterification reactor.

In some embodiments, an inlet of the catalyst preparation device is connected with an external methanol supply device and an ionic liquid catalyst supply device, the external methanol supply device provides methanol to the catalyst preparation device, and the ionic liquid catalyst supply device provides an ionic liquid catalyst to the catalyst preparation device; and

[symbol]

In some embodiments, the catalyst preparation device is provided with a stirring device for stirring an ionic liquid and a methanol liquid.

In some embodiments, the chemical pretreatment system as described in the above solutions further includes a mixing device having an inlet connected with an outlet of the catalyst preparation device, and an outlet connected with an inlet of the first esterification reactor, and a transfer pump is arranged between the mixing device and the catalyst preparation device.

In some embodiments, the catalyst preparation device is connected with at least one evaporation device of the evaporation device set through a pipeline, and a valve is arranged on a pipeline between the catalyst preparation device and the evaporation device connected therewith.

In some embodiments, the chemical pretreatment system as described in the above solutions further includes a second esterification reactor for subjecting raw oil and methanol that are unreacted after a reaction in the first esterification reactor to further reaction, an inlet of the second esterification reactor being connecting with another outlet of the first esterification reactor, an outlet of the second esterification reactor being connecting with the first separation device.

In some embodiments, the evaporation device set includes the first evaporation device and the second evaporation device arranged in parallel, the first evaporation device is provided for separating an oil phase product separated by the second separation device, and the second evaporation device is provided for separating a water phase product separated by the second separation device.

In some embodiments, the first evaporation device includes a first evaporator and a first gas-liquid separator arranged in series, the first evaporator is provided for heating the oil phase product, and the first gas-liquid separator is provided for subjecting a heated oil phase product from the first evaporator to a first gas-liquid separation; and
the second evaporation device includes a second evaporator and a second gas-liquid separator arranged in series, the second evaporator is provided for heating the water phase product, and the second gas-liquid separator is provided for subjecting a heated water phase product from the second evaporator to a second gas-liquid separation.

In some embodiments, the first gas-liquid separator and the second gas-liquid separator are arranged in parallel, and both connected with the cooling device, and methanol and water discharged from both the first gas-liquid separator and the second gas-liquid separator are introduced into the cooling device.

In some embodiments, the first esterification reactor and the second esterification reactor are both stirred tank reactors, and
the first separation device is a filter, and the second separation device is a chromatography device

[symbol]

The technical solution of the present disclosure has the following advantages:

For the chemical pretreatment system for waste FOG according to the present disclosure, a catalyst solution was prepared from methanol and an ionic liquid, and the methanol recycled from reactions is mixed with raw oil to be treated; after that, the methanol and the raw oil are subjected to an esterification reaction under the action of the catalyst to prepare a fatty acid methyl ester and water, thereby reducing the acid value of the raw oil and removing impurities such as metals, phospholipids, and unsaponifiable substances in the raw oil. In addition, the operation process of the system has a low loss rate of raw oil, a low process cost, and a decreased overall energy consumption.

### BRIEF DESCRIPTION OF THE DRAWINGS

In order to illustrate the specific embodiments of the present disclosure in detail, the accompanying drawings will be briefly introduced below. Obviously, the drawings in the following description are some embodiments of the present disclosure. Other drawings may be obtained by those skilled in the art based on these drawings without creative effort.

FIG. 1 shows an overall structure of a chemical pretreatment system for waste FOG according to the present disclosure; and

FIG. 2 shows another overall structure of a chemical pretreatment system for waste FOG according to the present disclosure.

The reference signs in the drawing are as follows:

1: catalyst preparation device; 2: esterification reactor; 21: first esterification reactor; 22: second esterification reactor; 3: first separation device; 4: second separation device; 41: first outlet; 42: second outlet; 5: evaporation device set; 51: first evaporation device; 511: first evaporator; 512: first gas-liquid separator; 52: second evaporation device; 521: second evaporator; 522: second gas-liquid separator; 6: cooling device; 7: methanol separation device; 8: reflux device; 9: methanol feed pump; 10: mixing device; and 20: raw oil supply device.

### DETAILED DESCRIPTION OF THE EMBODIMENTS

The technical solution of the present disclosure will be clearly and completely described below with reference to the accompanying drawings. Obviously, the described examples are some, not all, of the embodiments of the present disclosure. Based on the embodiments of the present disclosure, all other embodiments obtained by those skilled in the art without creative effort fall within the scope of the present disclosure.

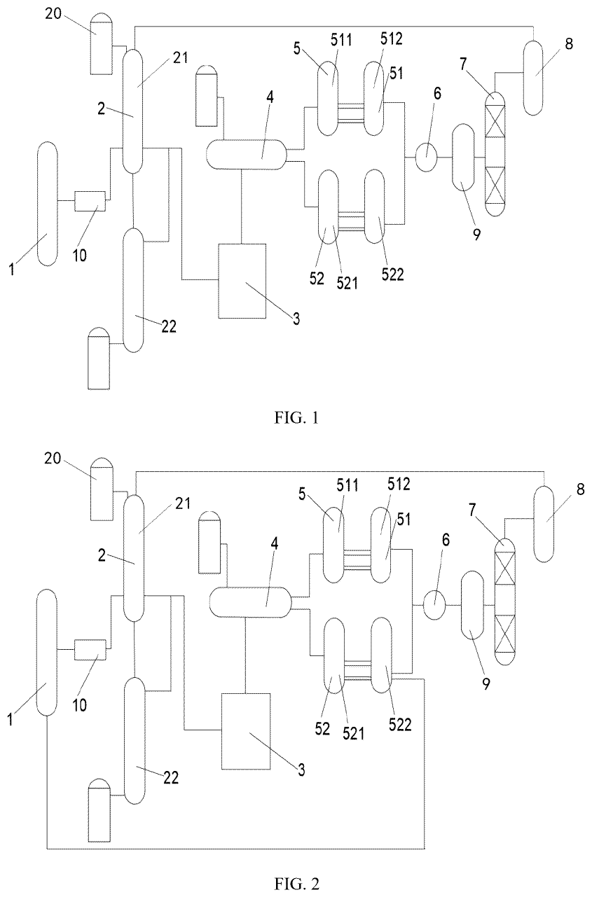

As shown in FIGS. 1 and 2, the present disclosure provides a chemical pretreatment system for waste FOG including: a catalyst preparation device 1, a first esterification reactor 21, a first separation device 3; a second separation device 4, an evaporation device set 5, a cooling device 6, a methanol separation device 7, a reflux device 8, and a raw oil supply device 20.

The catalyst preparation device 1 is configured to connect with an inlet of the first esterification reactor 21 for introducing a catalyst for raw oil reaction into the first esterification reactor 21. The raw oil supply device 20 is configured to connect with another inlet of the first esterification reactor 21 for providing raw oil, i.e., the waste FOG, to the first esterification reactor 21. The first separation device 3 is configured to connect with an outlet of the first esterification reactor 21 for separating a solid from a product discharged from the first esterification reactor 21.

The second separation device 4 is configured to connect with an outlet of the first separation device 3 by an inlet of the second separation device 4, for further separating oil and water phases of a product discharged from the first separation device 3.

The evaporation device set 5 is configured for evaporating the oil and water phases separated by the second separation device 4 to obtain methanol and water, and includes a first evaporation device 51 and a second evaporation device 52, where the first evaporation device 51 is connected with a first outlet 41 of the second separation device 4, and the second evaporation device 52 is connected with a second outlet 42 of the second separation device 4.

Outlets of the evaporation device set 5 are simultaneously connected with the cooling device 6, an outlet of the cooling device 6 is connected with the methanol separation device 7, an outlet of the methanol separation device 7 is connected with the reflux device 8. The cooling device 6 is provided for cooling methanol and water obtain by evaporation in the evaporation device set 5, and the methanol separation device 7 is configured for rectifying and separating methanol and water. The reflux device 8 is connected with the first esterification reactor 21, and the reflux device 8 is configured for introducing the methanol rectified and separated by the methanol separation device into the first esterification reactor 21.

In some embodiments, an inlet of the catalyst preparation device 1 is connected with an external methanol supply device and an ionic liquid catalyst supply device. The external methanol supply device provides methanol with a purity larger than 99% to the catalyst preparation device 1, and the ionic liquid catalyst supply device provides an ionic liquid catalyst with a purity larger than 99% to the catalyst preparation device 1. The external methanol supply device and the catalyst preparation device 1 are connected through a pipeline, and a valve is disposed on the pipeline between the external methanol supply device and the catalyst preparation device 1. The valve is provided for adjusting the flow rate of a methanol liquid from the external methanol supply device into the catalyst preparation device 1, so that the flexibility of catalyst preparation is improved to adapt to the waste FOG pretreatment requirements under different conditions. The ionic liquid catalyst supply device introduces the ionic liquid catalyst into the catalyst preparation device 1, and the ionic liquid catalyst supply device is fixed right above the catalyst preparation device 1 so as to timely supplement the ionic liquid catalyst into the catalyst preparation device 1 to ensure sufficient preparation of the catalyst solution. In order to better utilize the remaining ionic liquid catalyst in the reaction process of the system so as to reduce the consumption amount of the ionic liquid catalyst in the chemical pretreatment process of the waste FOG, the catalyst preparation device 1 connects with at least one evaporation device of the evaporation device set 5. The catalyst preparation device 1 connects with the evaporation device through a pipeline. A valve is arranged on the pipeline between the catalyst preparation device 1 and the evaporation device connecting therewith, and is provided for adjusting the flow rate of the ionic liquid catalyst introduced into the catalyst preparation device 1 from the corresponding evaporation device, so that the production flexibility of the whole system is improved. The ionic liquid catalyst which is evaporated by the evaporation device and then recycled is discharged from the evaporation device and introduced into the catalyst preparation device 1 to prepare the catalyst. The catalyst is prepared with a part of ionic liquid which is recycled, so that the consumption of the ionic liquid in the catalyst preparation process is reduced, the preparation cost is reduced, and the material utilization rate of the system is also improved. The catalyst preparation device 1 is provided with a stirring device, and the stirring device is provided for stirring the ionic liquid and the methanol liquid to promote the dissolution and mixing of the methanol and the ionic liquid. The ionic liquid catalyst is a Bronsted acid proton type ionic liquid.

An outlet of the catalyst preparation device 1 connects with a mixing device 10 through a pipeline, and the mixing device 10 connects with an inlet of the first esterification reactor 21. Specifically, the outlet of the catalyst preparation device 1 is provided with a transfer pump, and the transfer pump is used for introducing the prepared catalyst solution from the catalyst preparation device 1 into the mixing device 10 for sufficient mixing, so that the catalyst solution subsequently entering the first esterification reactor 21 rapidly participates in the reaction of methanol and raw oil, thereby improving the reaction efficiency of the esterification reaction and reducing the overall reaction time. In order to make the catalyst solution play a more effective catalytic role, the prepared catalyst solution is allowed to stand in the mixing device 10 for 5 minutes to 10 minutes and then introduced into the first esterification reactor 21.

The first esterification reactor 21 also connects with an external raw oil supply device. In order to further utilize the materials in the system after reactions, the first esterification reactor 21 may directly connect with the methanol separation device 7, and the methanol separated by the methanol separation device 7 is introduced into the first esterification reactor 21 for esterification reaction with raw oil to generate a fatty acid methyl ester and water. The generated fatty acid methyl ester and water are discharged from the first esterification reactor 21 and introduced into the first separation device 3 for subsequent separation.

In order to promote the reaction of the raw oil and improve the reaction efficiency of the whole system, the system further includes a second esterification reactor 22. The outlet of the first esterification reactor 21 connects with an inlet end of the second esterification reactor 22, and the second esterification reactor 22 is used for subjecting raw oil and methanol that are unreacted after the reaction in the first esterification reactor 21 to further reaction, so as to further promote the esterification reaction of the raw oil and methanol to generate a fatty acid methyl ester and water. Both the first esterification reactor 21 and the second esterification reactor 22 are stirred tank reactors. The first esterification reactor 21 and the second esterification reactor 22 are internally provided with spiral heating pipes, and the first esterification reactor 21 and the second esterification reactor 22 are externally provided with circulating heat exchangers. The steam condensate flows in the heating pipes located in the first esterification reactor 21 and the second esterification reactor 22, and is provided for heating methanol and the raw oil to promote the esterification reaction between the methanol and the raw oil. The circulating heat exchangers also connect with a cooling water pipeline, and the temperature of outer walls of the first esterification reactor 21 and the second esterification reactor 22 is adjusted and controlled by introducing cold water into the cooling water pipeline. In order to more effectively control the pressure inside the first esterification reactor 21 and the second esterification reactor 22, the first esterification reactor 21 and the second esterification reactor 22 respectively connect with a nitrogen pipeline, and the pressure inside the first esterification reactor 21 and the second esterification reactor 22 is adjusted by introducing nitrogen into the first esterification reactor 21 and the second esterification reactor 22.

The products generated by the reactions in the first esterification reactor 21 and the second esterification reactor 22 are respectively led out from the outlet of the first esterification reactor 21 and the outlet of the second esterification reactor 22 and introduced into the first separation device 3 for preliminary separation. The first separation device 3 is a filter, and the first separation device 3 can preliminarily remove solid impurities in the products after the reactions in the first esterification reactor 21 and the second esterification reactor 22. An outlet of the first separation device 3 connects with a waste residue treatment storage tank, and the filtered solid impurities are discharged from the first separation device 3 and introduced into the waste residue treatment storage tank for collection. In some embodiments, the first separation device is a plate-and-frame filter press.

The product separated by the first separation device 3 enters the second separation device 4. The second separation device 4 is a chromatography device, and two outlets of the second separation device 4 respectively connect with two evaporation devices. The second separation device 4 is used for subjecting the product filtered by the first separation device 3 to oil-water phase separation to respectively obtain an oil phase product and a water phase product. The oil phase product is mainly a fatty acid methyl ester, methanol, water, and a part of raw oil that does not react, and the water phase product is mainly methanol, an ionic liquid, and water generated by the reaction. The evaporation device set 5 includes a first evaporation device 51 and a second evaporation device 52. The first evaporation device 51 and the second evaporation device 52 are disposed in parallel with each other, and the first evaporation device 51 is used for separating the oil phase product obtained by the second separation device 4. The first evaporation device 51 includes a first evaporator 511 and a first gas-liquid separator 512 connected with each other. The first evaporator 511 is used for heating the oil phase product, and a heated oil phase product is introduced into the first gas-liquid separator 512 connected with the first evaporator 511, for gas-liquid separation. The first gas-liquid separator 512 is used for separating the heated oil phase product into gas and liquid. Specifically, the oil phase product is heated by using differences in boiling point among water, methanol, and the fatty acid methyl ester to separate methanol and water from the oil phase product. A resulting crude product containing the fatty acid methyl ester and unreacted raw material oil after separating methanol and water from the oil phase product is discharged from the first gas-liquid separator 512 and introduced into a storage device for subsequent reaction. The first evaporation device 51 connects with a steam heating pipeline, and the steam heating pipeline also connects with the first esterification reactor 21. A steam with a relatively high temperature is introduced into the steam heating pipeline, and heat is transferred to the oil phase product located in the first evaporation device 51 along with the flow of the steam to promote the heating of the oil phase product. The oil phase product is heated by such steam. After heating, a resulting cooled steam is then introduced into the first esterification reactor 21 to control the reaction temperature in the first esterification reactor 21.

Similarly, the second evaporation device 52 is used for separating the water phase product obtained by separation in the second separation device 4. The second evaporation device 52 includes a second evaporator 521 and a second gas-liquid separator 522 connected with each other. The second evaporator 521 is used for heating the water phase product, and a heated water phase product enters the second gas-liquid separator 522 connected with the second evaporator 521, for gas-liquid separation. The second gas-liquid separator 522 is used for separating the heated water phase product into gas and liquid. Specifically, the ionic liquid, methanol, and water are separated in a flash evaporation manner by using differences in boiling point among the ionic liquid, methanol, and water, and the methanol and water are obtained by evaporation, so that the methanol and water are separated from the ionic liquid. The separated methanol and water are discharged from the second evaporation device 52 for subsequent further separation. In order to reuse the separated ionic liquid catalyst, reduce the catalyst consumption of the chemical pretreatment system for the waste FOG, and thereby reduce the pretreatment cost, the second gas-liquid separator 522 connects with the catalyst preparation device 1, and after being discharged from the second gas-liquid separator 522, the separated ionic liquid catalyst may be introduced into the catalyst preparation device 1 to prepare the catalyst solution and reduce the cost of the system. There is partially deactivated ionic liquid in the separated ionic liquid catalyst. In order to reduce the influence of the deactivated ionic liquid catalyst on the subsequent reaction, the second gas-liquid separator 522 is further provided with a separation device for separating the deactivated ionic liquid catalyst and the recyclable ionic liquid, and discharging the deactivated ionic liquid out of the second gas-liquid separator 522 for recovery and collection.

The second evaporation device 52 connects with the steam heating pipeline, and the steam heating pipeline also connects with the first esterification reactor 21. A steam with a relatively high temperature is introduced into the steam heating pipeline, and heat is transferred to the water phase product located in the second evaporation device 52 along with the flow of the steam to promote the heating of the water phase product. The water phase product is heated by such steam. After heating, a resulting cooled steam is then introduced into the first esterification reactor 21 to control the reaction pressure in the first esterification reactor 21.

The first gas-liquid separator 512 and the second gas-liquid separator 522 are disposed in parallel with each other. Both the first gas-liquid separator 512 and the second gas-liquid separator 522 are connected with the cooling device 6. The methanol and water discharged from the first gas-liquid separator 512 and the methanol and water discharged from the second gas-liquid separator 522 enter the cooling device 6. The cooling device 6 may further cool the methanol and water introduced from the first gas-liquid separator 512 and the second gas-liquid separator 522. The cooling device is a methanol condenser.

An outlet of the cooling device 6 connects with an inlet of the methanol separation device 7. Methanol and water cooled by the cooling device 6 enter the methanol separation device 7. The cooling device 6 connects with the methanol separation device 7 through a pipeline. A methanol feed pump 9 is arranged on the pipeline connecting the cooling device 6 and the methanol separation device 7, and the methanol feed pump 9 can increase the pressure in the pipeline, so that the methanol and water can enter the methanol separation device 7 more quickly. The methanol separation device 7 can be used for subjecting the cooled methanol and water to rectification separation to obtain methanol with a purity larger than 99%. In order to better promote the reaction of the raw oil and improve the recycling rate of the system, an outlet of the methanol separation device 7 connects with the reflux device 8, and the separated methanol with a purity larger than 99% is introduced into the reflux device 8. The reflux device 8 connects with the first esterification reactor 21, and the reflux device 8 can re-introduce the methanol with a purity larger than 99% into the first esterification reactor 21 for a continuous reaction with the raw oil to prepare a fatty acid methyl ester and water, thereby achieving the effect of recycling the methanol. A resulting wastewater after rectification is discharged from the bottom of the methanol separation device 7 and introduced into the wastewater storage device.

Specifically, during use, methanol and an ionic liquid catalyst are introduced into the catalyst preparation device 1 simultaneously. In order to reduce consumption amount of raw materials, the ionic liquid catalyst separated in the second gas-liquid separator 522 is synchronously introduced into the catalyst preparation device 1, and methanol and the ionic liquid catalyst are mixed and stirred to be uniform in the catalyst preparation device 1 to prepare a catalyst solution. The catalyst solution is discharged from the catalyst preparation device 1 and then enters the mixing device 10 and stands therein for 6 minutes to 8 minutes, and then is introduced into the first esterification reactor 21. At this time, the raw oil and methanol are simultaneously introduced into the first esterification reactor 21 and subjected to an esterification reaction. In order to effectively utilize the materials in the system and reduce the consumption of external raw materials to decrease the operation cost, the methanol separated by rectification in the methanol separation device 7 is introduced into the first esterification reactor 21. Meanwhile, the reaction temperature and the reaction pressure in the first esterification reactor 21 are adjusted, and the methanol and the raw oil are subjected to esterification reaction under the action of the ionic liquid catalyst to prepare a fatty acid methyl ester and water. The methanol and raw oil that are not reacted are introduced into the second esterification reactor 22 from the first esterification reactor 21, and then subjected to further esterification reaction after adjusting the reaction temperature and the reaction pressure therein.

The fatty acid methyl ester and water prepare after the reactions in the first esterification reactor 21 and the second esterification reactor 22 are respectively discharged from the first esterification reactor 21 and the second esterification reactor 22 and then enter the first separation device 3 and subjected to filtration to preliminarily remove solid impurities in the product. After filtration, a resulting product is discharged from the first separation device 3 and then introduced into the second separation device 4, and separated therein into an oil phase product and a water phase product. The oil phase product enters the first evaporation device 51 connected with the second separation device 4, and the water phase product enters the second evaporation device 52 connected with the second separation device 4. The oil phase product is further evaporated and separated in the first evaporation device 51 by differences in boiling point among water, methanol, and the fatty acid methyl ester to obtain methanol and water. The water phase product is further evaporated and separated in the second evaporation device 52 by differences in boiling point among an ionic liquid, methanol, and water to obtain methanol and water. Methanol and water obtained by evaporation in the first evaporation device 51 and the second evaporation device 52 simultaneously enter the cooling device 6 and are subjected to condensation to obtain a liquid of methanol and water. The condensed liquid of methanol and water is discharged from the cooling device 6 and enters the methanol separation device 7, and then is rectified therein to obtain methanol with a purity larger than 99%. The resulting wastewater after rectification is discharged from the methanol separation device 7.

The parts not described in the present invention are applicable to the prior art.

Obviously, the above-described embodiments are only examples for clear illustration and are not intended to limit the embodiments. Other different forms of changes or modifications may be made by those skilled in the art based on the above description. An exhaustive list of all embodiments is neither necessary nor possible. The obvious changes or modifications derived therefrom are still within the scope of the present disclosure.

1. A chemical pretreatment system for waste fat, oil and grease (FOG), comprising: a catalyst preparation device (1), a first esterification reactor (21), a first separation device (3); a second separation device (4), an evaporation device set (5), a cooling device (6), a methanol separation device (7), a reflux device (8), and a raw oil supply device (20);
wherein the catalyst preparation device (1) is configured to connect with an inlet of the first esterification reactor (21) for introducing a catalyst for reaction of raw oil into the first esterification reactor (21);
the raw oil supply device (20) is configured to connect with another inlet of the first esterification reactor (21) for providing raw oil, i.e. the waste FOG, to the first esterification reactor (21);
the first separation device (3) is configured to connect with an outlet of the first esterification reactor (21) for separating a solid from a product discharged from the first esterification reactor (21);
the second separation device (4) is configured to connect with an outlet of the first separation device (3) by an inlet of the second separation device (4), for further separating oil and water phases of a product discharged from the first separation device (3);
the evaporation device set (5) is configured for evaporating the oil and water phases separated by the second separation device (4) and comprises a first evaporation device (51) and a second evaporation device (52), the first evaporation device (51) being connected with a first outlet (41) of the second separation device (4), and the second evaporation device (52) being connected with a second outlet (42) of the second separation device (4); and
outlets of the evaporation device set (5) are simultaneously connected with the cooling device (6), an outlet of the cooling device (6) is connected with the methanol separation device (7) configured for rectifying and separating methanol and water, an outlet of the methanol separation device (7) is connected with the reflux device (8), and the reflux device (8) is connected with the first esterification reactor (21) and configured for introducing the methanol rectified and separated by the methanol separation device (7) into the first esterification reactor (21).

2. The chemical pretreatment system for the waste FOG according to claim 1, wherein an inlet of the catalyst preparation device (1) is connected with an external methanol supply device and an ionic liquid catalyst supply device, the external methanol supply device provides methanol to the catalyst preparation device (1), and the ionic liquid catalyst supply device provides an ionic liquid catalyst to the catalyst preparation device (1); and
the catalyst preparation device (1) is provided with a stirring device for stirring an ionic liquid and a methanol liquid.

3. The chemical pretreatment system for the waste FOG according to claim 2, wherein the chemical pretreatment system further comprises a mixing device (10) having an inlet connected with an outlet of the catalyst preparation device (1), and an outlet connected with an inlet of the first esterification reactor (21), and a transfer pump is arranged between the mixing device (10) and the catalyst preparation device (1).

4. The chemical pretreatment system for the waste FOG according to claim 3, wherein the catalyst preparation device (1) is connected with at least one evaporation device of the evaporation device set (5) through a pipeline, and a valve is arranged on the pipeline between the catalyst preparation device (1) and the evaporation device connected therewith.

5. The chemical pretreatment system for the waste FOG according to claim 4, wherein the chemical pretreatment system further comprises a second esterification reactor (22) for subjecting raw oil and methanol that are unreacted after a reaction in the first esterification reactor (21) to further reaction, an inlet of the second esterification reactor (22) being connecting with another outlet of the first esterification reactor (21), an outlet of the second esterification reactor (22) being connecting with the first separation device (3).

6. The chemical pretreatment system for the waste FOG according to claim 5, wherein the evaporation device set (5) comprises the first evaporation device (51) and the second evaporation device (52) arranged in parallel, the first evaporation device (51) is provided for separating an oil phase product separated by the second separation device (4), and the second evaporation device (52) is provided for separating a water phase product separated by the second separation device (4).

7. The chemical pretreatment system for the waste FOG according to claim 6, wherein the first evaporation device (51) comprises a first evaporator (511) and a first gas-liquid separator (512) arranged in series, the first evaporator (511) is provided for heating the oil phase product, the first gas-liquid separator (512) is provided for subjecting a heated oil phase product from the first evaporator to a first gas-liquid separation; and
the second evaporation device (52) comprises a second evaporator (521) and a second gas-liquid separator (522) arranged in series, the second evaporator (521) is provided for heating the water phase product, and the second gas-liquid separator (522) is provided for subjecting a heated water phase product from the second evaporator (521) to a second gas-liquid separation.

8. The chemical pretreatment system for the waste FOG according to claim 7, wherein the first gas-liquid separator (512) and the second gas-liquid separator (522) are arranged in parallel, and both connected with the cooling device (6), and methanol and water discharged from both the first gas-liquid separator (512) and the second gas-liquid separator (522) are introduced into the cooling device (6).

9. The chemical pretreatment system for the waste FOG according to claim 8, wherein the first esterification reactor (21) and the second esterification reactor (22) are both stirred tank reactors, and
the first separation device (3) is a filter, and the second separation device (4) is a chromatography device.
